(19) United States
(12) Patent Application Publication
(10) Pub. No.: US 2017/0151861 A1
(43) Pub. Date: Jun. 1, 2017

(54) AUTOMOBILE SUNSHADE

(71) Applicant: Muhammad Hamza Aslam, Los Angeles, CA (US)

(72) Inventor: Muhammad Hamza Aslam, Los Angeles, CA (US)

(21) Appl. No.: 15/365,853

(22) Filed: Nov. 30, 2016

Related U.S. Application Data
(60) Provisional application No. 62/260,726, filed on Nov. 30, 2015.

(51) Int. Cl. B60J 1/20; E06B 9/24

(52) U.S. Cl. CPC B60J 1/2011; E06B 9/24; E06B 2009/2494

(57) ABSTRACT

A car sunshade may include a supporting frame and a sunscreening fabric enclosed by the supporting frame. In one embodiment, the supporting frame of the car sunshade is made of a predetermined polygonal shape, depending on the shape of the car window. The supporting frame can be made by a resilient material, so it can be slightly bent to snap on the car window. The supporting frame may have an upper and a lower side, and the user can align and insert the lower side into the lower receiving groove, slightly bend the sunshade to insert the upper side into the upper receiving groove, and slight move the sunshade to the side groove. The sunscreening fabric can be extended and the sunshade can be perfectly secured in the frame of the car window without using any additional equipment, suction cups, or adhesive.

### CROSS-REFERENCE OF RELATED APPLICATIONS

This application claims priority under 35 U.S.C. §119 (e) to U.S. Provisional Patent Application Ser. No. 62/260,726, filed on Nov. 30, 2015, the entire contents of which are hereby incorporated by reference.

### FIELD OF THE INVENTION

The present invention relates to sunshades or sunshields for automobiles, and more particularly to sunshades that can be easily secured on the windows or windshields of the automobiles to shield the light and heat from the sun.

### BACKGROUND OF THE INVENTION

It is well known that the heat built-up within a closed automotive vehicle can reach very high temperatures particularly in the warrner areas of the country having intense sunshine. Not only is interior vehicular heat uncomfortable for people who must enter such vehicles, the heat places a very heavy load on vehicular air conditioning equipment, which shortens the life of the equipment and, of course, increases the operating costs. In addition, prolonged exposure to ultra-violet light and the heat itself, can damage, and sometimes destroy the plastic, fabric, and other materials within the vehicle. Thus, sunscreening devices for automobiles have been developed to not only increase the comfort level for the passengers in the automobiles, but also protect the interiors thereof.

U.S. Pat. No. 5,024,262 to Huang, U.S. Pat. No. 4,815,784 to Zheng, U.S. Pat. No. 5,732,759 to Wan, and U.S. Pat. No. 5,553,908 to Shink all teach about sunshades for automobiles, however, these sunshades are solely for the purpose of blocking sunlight at a window or windshield when the vehicle is parked. None of these sunshades are capable of being used when the vehicle is in motion. U.S. Pat. No. 8,342,226 to Zheng discloses a collapsible sunshade which can be used when the vehicle is in motion. However, the collapsible sunshade needs a suction cup to attach it to the inner surface of the vehicle window. The suction cup, which is usually made by plastic materials, will most likely be deformed or deteriorate if it is constantly exposed in a high temperature environment, and the collapsible sunshade may then fall off from the vehicle window.

Therefore, there remains a need for a new and improved sunshade for automobiles that can be easily secured on the vehicle windows without using any additional equipment, suction cups or adhesives that may damage or deteriorate the vehicle windows.

### SUMMARY OF THE INVENTION

It is an object of the present invention to provide a sunshade that can be quickly snapped onto the window and easily removed when not in use.

It is another object of the present invention to provide a sunshade, the size of which can be adjusted to perfectly fit onto the window.

It is a further object of the present invention to provide a sunshade that can be snapped onto the window without any additional equipment, suction cups, or adhesive.

In one aspect, a car sunshade may include a supporting frame and a sunscreening fabric enclosed by the supporting frame. In one embodiment, the supporting frame of the car sunshade is made of a predetermined polygonal shape, depending on the shape of the car window. The supporting frame can be made by a resilient material, so it can be slightly bent to snap on the car window.

More specifically, the supporting frame may have an upper and a lower side. A plurality of receiving grooves may be formed between a car window and the inner portion of the car door. In one embodiment, the user can align and insert the lower side into the lower receiving groove, slightly bend the sunshade to insert the upper side into the upper receiving groove, and slight move the sunshade to the side groove. Since the supporting frame is made by resilient materials, the sunscreening fabric can be extended and the sunshade can be perfectly secured in the frame of the car window without using any additional equipment, suction cups, or adhesive.

The sunshade can be easily removed from the frame of the car window. In one embodiment, the user can push the sunshade away from the side groove, and remove it from the lower side from the lower receiving groove, and the entire sunshade can be taken out from the window. In another embodiment, the user can also remove it from the upper receiving groove first.

### BRIEF DESCRIPTION OF THE DRAWINGS

FIG. 1 illustrates a schematic view of the sunshade in the present invention.

FIG. 2 illustrates a schematic view of the sunshade in the present invention snapped onto the car window without using any additional equipment, suction cups, or adhesive.

FIG. 3 illustrates a schematic view of the sunshade that can be snapped onto the rear windshield.

FIG. 4 illustrates a schematic view of the sunshade in the present invention snapped onto the rear windshield.

FIG. 5 illustrates a schematic view of the sunshade in the present invention snapped onto the corner window.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

As used in the description herein and throughout the claims that follow, the meaning of “a”, “an”, and “the” includes reference to the plural unless the context clearly dictates otherwise. Also, as used in the description herein and throughout the claims that follow, the terms “comprise or comprising”, “include or including”, “have or having”, “contain or containing” and the like are to be understood to be open-ended, i.e., to mean including but not limited to. As used in the description herein and throughout the claims that follow, the meaning of “in” includes “in” and “on” unless the context clearly dictates otherwise.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the embodiments. As used herein, the term “and/or” includes any and all combinations of one or more of the associated listed items.

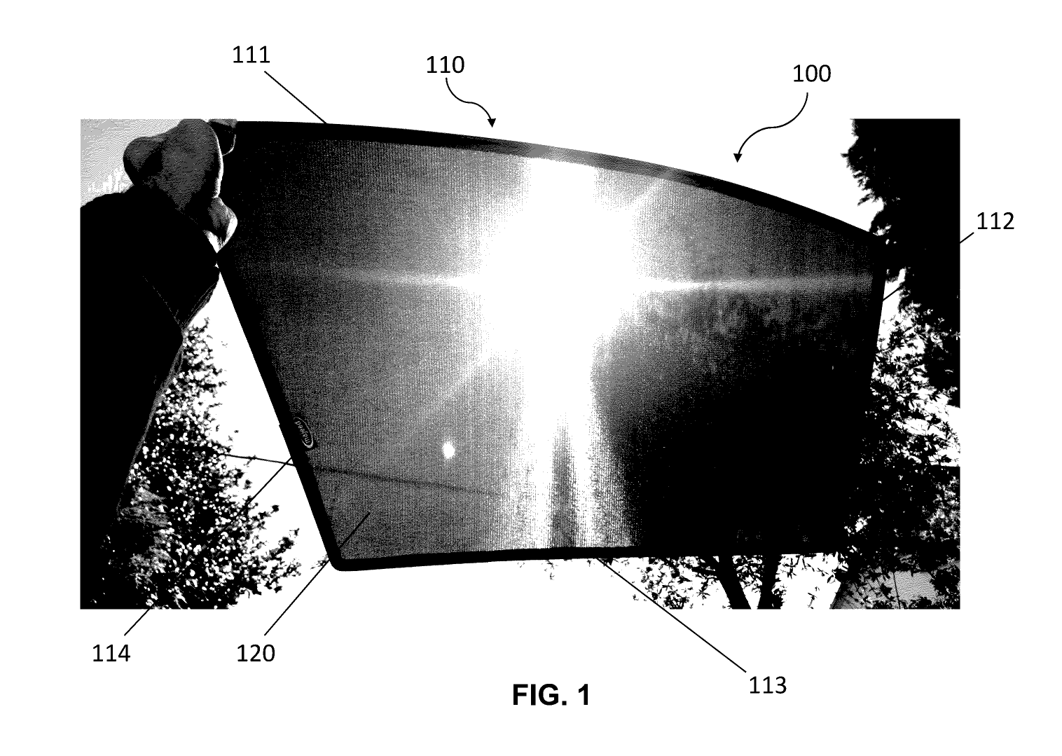

In one aspect, referring to FIG. 1, a car sunshade 100 may include a supporting frame 110 and a sunscreening fabric 120 enclosed by the supporting frame 110. In one embodiment, the supporting frame 110 of the car sunshade 100 is made of a predetermined polygonal shape, depending on the shape of the car window. The supporting frame 110 can be made by a resilient material, so it can be slightly bent to snap on the car window.

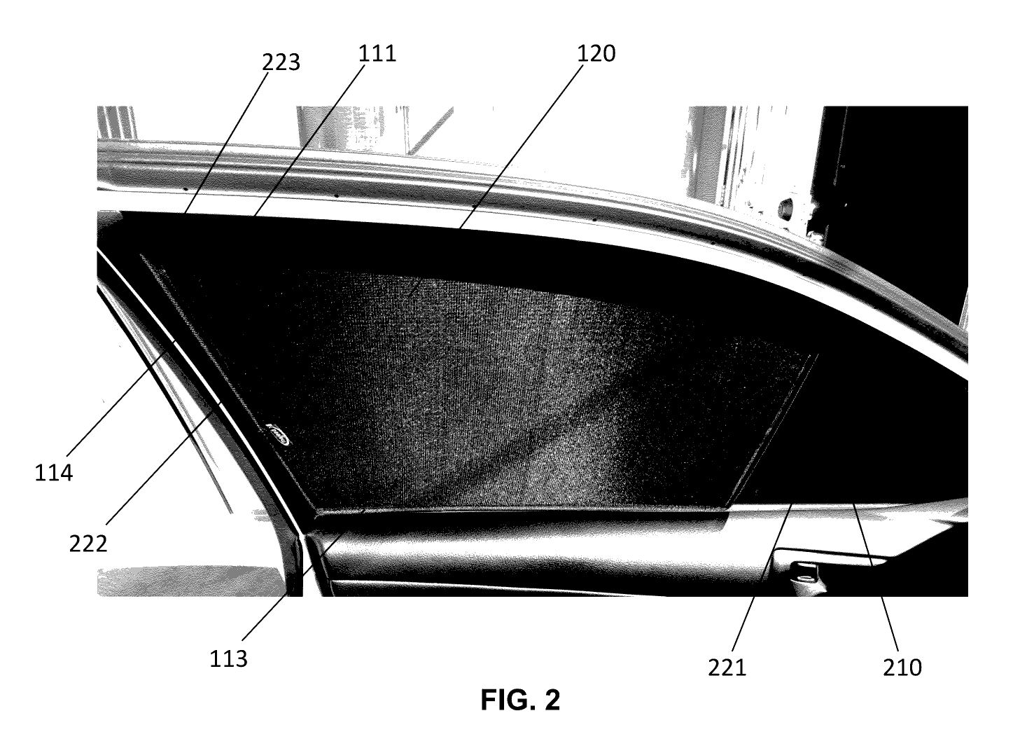

More specifically, the supporting frame 110 may have a first side 111, a second side 112, a third side 113 and a fourth side 114. As shown in FIG. 2, a plurality of receiving grooves (221, 222, 223) may be formed between a car window 210 and the inner portion of the car door. In one embodiment, the user can align and insert the third side 113 into the lower receiving groove 221, slightly bend the sunshade 100 to insert the first side 111 into the upper receiving groove 223, and slight move the sunshade 100 to the side groove 222. Since the supporting frame 110 is made by resilient materials, the sunscreening fabric 120 can be extended and the sunshade 100 can be perfectly secured in the frame of the car window without using any additional equipment, suction cups, or adhesive.

Still referring to FIG. 2, the sunshade 100 can be easily removed from the frame of the car window. In one embodiment, the user can push the sunshade 100 away from the side groove 222, and remove it from the third side 113 from the lower receiving groove 221, and the entire sunshade 100 can be taken out from the window. In another embodiment, the user can also remove it from the upper receiving groove 223 first.

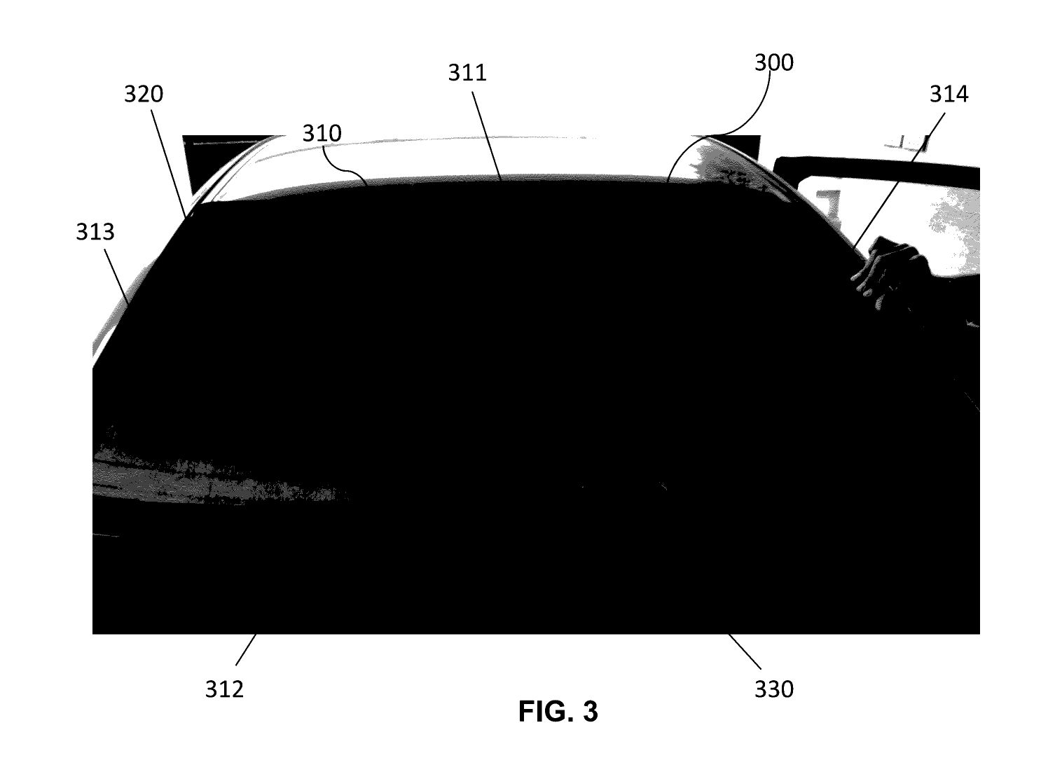

In another aspect, a sunshade 300 may include a supporting frame 310 and a sunscreening fabric 320 enclosed by the supporting frame 310. In one embodiment, the supporting frame 310 of the car sunshade 300 is made of a predetermined polygonal shape, depending on the shape of the car window, as shown in FIG. 3. The supporting frame 310 can be made by a resilient material, so it can be slightly bent to snap on the car window.

As discussed above in FIGS. 1 and 2, the sunshade in the present invention is configured to snap onto the window without using any additional equipment, suction cups, or adhesive. The same “snap on” mechanism can be applied to secure the sunshade 300 to the rear windshield 330.

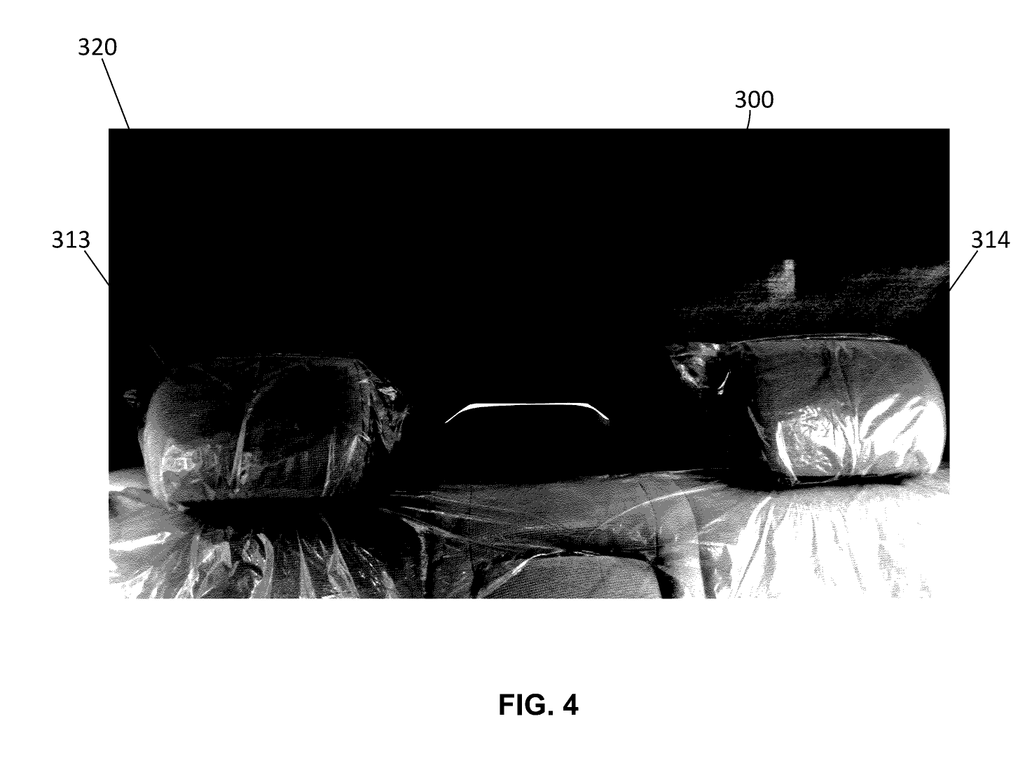

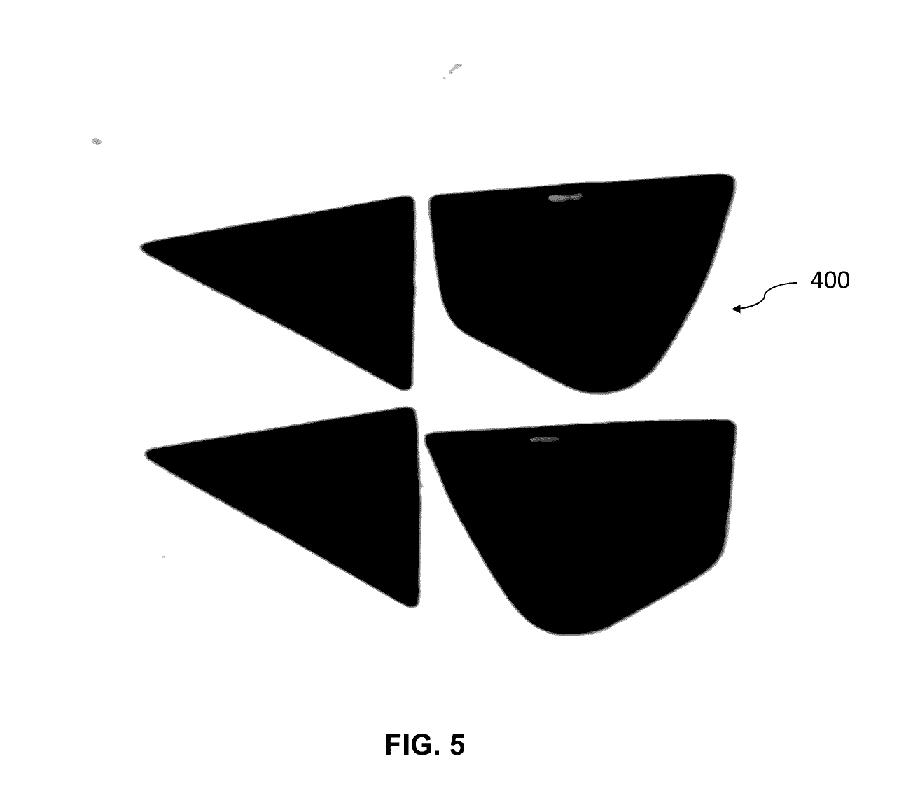

More specifically, the supporting frame 310 may include a first side 311, a second side 312, a third side 313 and a fourth side 314, and a plurality of receiving grooves (not shown) may be formed between the rear windshield 330 and the inner portion of the car close to rear windshield 330. As shown in FIG. 4, the sunshade 300 can be snapped onto the inner portion of the rear windshield 330 by first inserting the first side 311 into the upper receiving groove (not shown), slightly bending the sunshade 300 and inserting the second side 312 into the lower receiving groove (not shown). The user can then adjust the position of the sunshade 300 so the third side 313 and fourth side 314 can both fit into the side receiving grooves (not shown). In still another aspect, the shape of the sunshade can be adjusted according to the shape of the window or windshield. In a further aspect, a sunshade 400 can be snapped onto the corner window of the vehicle as shown in FIG. 5.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A car sunshade comprising a polygonal supporting frame and a sunscreening fabric enclosed by said supporting frame; the supporting frame of the car sunshade made by a resilient material, so it is configured to be slightly bent to snap onto a car window.

2. The car sunshade of claim 1, wherein the shape of the polygonal supporting frame is determined by the shape of the car window.

3. The car sunshade of claim 1, wherein the supporting frame includes a plurality of sides, which are configured to be received by corresponding receiving grooves formed between the car window and an inner portion of the car door.

4. The car sunshade of claim 3, wherein a lower side of the supporting frame is aligned and inserted the into the lower corresponding receiving groove, and the sunshade is slightly bent to insert an upper side of the supporting frame into the upper corresponding receiving groove, and the sunshade is then being moved to the corresponding side groove to secure the sunshade on the car window.

5. The car sunshade of claim 4, the sunshade is removed from the car window when the sunshade is moved away from the side groove of the car window and taken away from the car window by a slightly bending action from the upper side and lower side of the supporting frame.

6. The car sunshade of claim 1, wherein the sunshade is configured to be snapped onto corner windows of a vehicle.

7. The car sunshade of claim 1, wherein the sunshade is configured to be snapped onto a windshield or rear window of a vehicle.
